(19) United States
(12) Patent Application Publication
(10) Pub. No.: US 2007/0147438 A1
(43) Pub. Date: Jun. 28, 2007

(54) DIRECTED MULTIPLEXING OF DATA TRAFFIC IN A LINK CONTROL ENVIRONMENT

(75) Inventor: Simon LOK, Vero Beach, FL (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: LOK TECHNOLOGY, INC., Vero Beach, FL (US)

(21) Appl. No.: 11/539,157

(22) Filed: Oct. 5, 2006

Related U.S. Application Data
(60) Provisional application No. 60/596,615, filed on Oct. 6, 2005.

(51) Int. Cl. H04J 3/04

(52) U.S. Cl. 370/535

(57) ABSTRACT

A link controller that is capable of asymmetric network traffic multiplexing. A typical link controller treats all provisioned links as being equal (i.e., traffic is symmetrically multiplexed or distributed between all provisioned links) except when a link failure is detected. Our link controller is capable of modifying the multiplexing behavior of the link controller based on a wide range of parameters including but not limited to link characteristics, network traffic type, source and/or destination address, link saturation and overall network load.

### FIELD OF THE INVENTION

The present invention relates, in general, to network data communications, and, more particularly, to software, systems and methods for aggregation and fail-over of multiple wide area network connections for increased throughput and reliability.

### RELEVANT BACKGROUND

Wide area network connectivity is typically at least an order of magnitude lower in throughput and higher in latency than what is available on local area networks. In addition, traditional leased-line wide area network connectivity involves high monthly recurring charges, multi-year contract commitments and long installation lead times.

Growing businesses with rapidly changing bandwidth requirements are caught in a quandary. Immediately committing to a high bandwidth wide area leased line ensures capacity for future growth but forces the business to expend cash for an underutilized resource. For example, a 15 Mbps fractional T-3 costs in excess of $4,500 a month in most major metropolitan areas. Installing a more modest wide area leased line results in more manageable monthly recurring charges, but multi-year contracts and long lead times make it difficult to modify the service level being delivered. In addition, as the availability of the network becomes critical to sustain a growing business, simultaneous provisioning of multiple, diverse, wide area network connections, becomes an important issue. In order to alleviate some of these difficulties, techniques such as multiple link bonding (multilink) and multiple home addressing (multi-home) have been developed to simultaneously provision multiple independent Internet uplinks to increase throughput and reliability.

Multilink technology allows a business to incrementally add bandwidth by bonding multiple channels or links that originate from the same wide area network. A bonding device is placed at both ends of a set of similar links that run between the wide area network and the business' local area network. By distributing traffic over multiple links, the throughput between the ISP and the client network is increased linearly. For example, two 1.544 Mbps T-1 s may be bonded to achieve 3.088 Mbps of effective throughput. A third T-1 may added to make the effective throughput 4.632 Mbps, etc.

There are many disadvantages to the multiple link bonding approach. First, a bonding device must be present on both the local area network and the wide area network. If the wide area network connectivity is being used to obtain Internet access, an ISP has control of the datacenter on the far end of the wide area connections. The ISP may not be willing to deploy multilink technology on its network or in its datacenter. Switching to an ISP that supports multilink is generally the only solution.

Further, many bonding protocols do not support fail-over. If there is failure of one of the individual links that make up the multilink wide area connection, the wide area connection may either completely cease to function or drop every n-th packet. Finally, multilink cannot support wide area network redundancy. Bonded links must all be connected to the same wide area network. When the wide area network is used for Internet connectivity, the business' network will go down if the wide area network suffers a network outage.

Another approach to provisioning multiple wide area network links is to deploy a multi-homed network by utilizing the Border Gateway Protocol (BGP). A multi-homed network has multiple connections to a network such as the Internet. BGP is designed as an inter-domain routing protocol and is designed to enable IP routers to direct packets traversing along the Internet from point A to point B. While BGP is a core technology for routing, implementing multi-homing using BGP can be extremely difficult and does not provide a proper mechanism for ensure dynamic, flexible routing based on link performance, corporate policy or utilization cost models. Unlike multilink technologies, multi-homed BGP network configurations generally are used to achieve redundancy with wide area network links terminating at different locations (e.g., different ISPs).

Inbound path redundancy is achieved through the cooperation of all BGP enabled routers within the wide area network. Each BGP router independently detects the existence of the multiple paths to the business' local area network by interpreting BGP announcements made by the edge router on the business network. If a link fails, announcements across that link stop and all BGP enabled routers on the wide area network will compensate for the changed network topology.

Outbound path redundancy is achieved by allowing the business' edge router to make decisions about which wide area network link to use. Links that are not receiving BGP announcements from the “peer” router on the other side of the wide area network link are avoided. In addition, the BGP protocol allows a network administrator to specify a set of outbound path preferences based on the destination network address.

Unfortunately, deploying BGP is a difficult process that involves high capital costs and recurring costs, time consuming negotiations with regulatory bodies and managing multiple competitive entities. In order for the business' network to be recognized as a leaf-node on the Internet, the business must request an autonomous system number (ASN) from the American Registry of Internet Numbers (ARIN). Since there are only 65,536 possible ASNs, ARIN has very strict policies on distributing ASNs. The business must then coordinate with all wide area network service providers to permit the newly assigned ASN to route traffic. Cooperation between all parties, including service providers that are competing against one another, is necessary to deploy a working multi-homed BGP configuration. The business must also procure, deploy and maintain one or more BGP routers on the local area network edge.

In addition, the path preference system built into BGP (ASPath) is static and based solely on the destination network address. Unless there is a link failure, packets destined for the same network will always use the same wide area network link even if there is a different link that will result in faster delivery. Thus, a business network that deploys a multi-homed BGP configuration over two T-1 s is paying for 3.088 Mbps of overall bandwidth but will not be able to have access to the full bandwidth without going through extreme measures.

Link control is an emerging alternative to multilink bonding and network multi-homing for simultaneous provisioning of multiple wide area network connections. Unlike multilinking and multi-homing, all of the intelligence needed for link aggregation and failover resides within the link controller customer provided equipment (CPE). Thus, local area network operators are empowered with the ability to aggregate failover links that are connected to a diverse set of wide area networks without cooperation of the wide area network operators.

Link control is usually deployed by businesses that wish to reduce monthly recurring charges for Internet links. Typically, a business will use link control with multiple digital subscriber lines (DSLs) that each costs under $100 per month in lieu of a leased T-1 or T-3 line that costs hundreds to thousands of dollars per month. For example, deploying six link controller ADSLs that provide 18 Mbps of downstream bandwidth costs under $600 per month while a fractional T-3 providing 15 Mbps of downstream bandwidth costs $4,000 per month. In addition, DSLs typically have very short installation lead times (days) compared to leased lines (months). Since link control does not require wide area network operator cooperation, a growing business can provision two or three DSLs to begin with and rapidly respond to changing bandwidth requirements on terms that are favorable to the business.

A link controller aggregates bandwidth by treating the available wide area network connections as a pool. In a typical link control environment, local area network nodes or individual sessions originating from the local area network are assigned wide area network links in a round-robin fashion. However, link control can be used to support more complex network topologies. For example, a link controller can be connected to multiple wide area connections that terminate on different networks because link control does not require the cooperation of the wide area network operator. The possibilities are only limited by the sophistication of the link controller CPE.

One device that addresses these issues is called the BIG-IP Link controller available from F5 Networks. While the BIG-IP Link controller offers some increased ability to intelligently direct traffic, it does not fully address the limitations of the prior art. A need remains for systems and methods for intelligently aggregating links for multiple wide area network connections for increased throughput, availability, and reliability.

### SUMMARY OF THE INVENTION

Briefly stated, the present invention involves a link controller that is capable of asymmetric network traffic multiplexing. A typical link controller treats all provisioned links as being equal (i.e., traffic is symmetrically multiplexed or distributed between all provisioned links) except when a link failure is detected. A link controller provisions one or more local area network links and multiple wide area network links and is configured to deposit packet data and link meta data into a unified buffer. The link controller is capable of modifying the multiplexing behavior of the link controller based on a wide range of parameters including but not limited to link characteristics, network traffic type, source and/or destination address, link saturation and overall network load.

### BRIEF DESCRIPTION OF THE DRAWINGS

FIG. 1 shows a typical multilink bonding network topology.

FIG. 2 shows a typical multi-homed network topology.

FIG. 3 shows a typical link control network topology.

FIG. 4 shows the architecture of the directed multiplexing link controller in accordance with the present invention.

FIG. 5 shows a network topology provisioned by our directed multiplexing link controller invention.

### DETAILED DESCRIPTION OF THE PREFERRED EMBODIMENT

The present invention is directed to systems that provide an alternative solution to the problems and limitations of previous solutions. The present invention integrates a link controller with a battery of network instruments and a policy enforcement engine. This combination allows network traffic to be intelligently directed amongst communication channels that intelligently and dynamically share the network resources available over multiple wide area network (WAN) links. Unlike prior link controllers, the present invention is able to provision wide area network (WAN) links independently and asymmetrically. In other words, bandwidth from two or more disparate WAN links can be thought of as pooled network communication resources. The pooled resources can be provisioned to support particular communication needs independently of the characteristics of the WAN links from which those communication resources are drawn. Moreover, provisioned links may exhibit disparate bandwidth and asynchronous bandwidth (i.e., different upstream and downstream bandwidths).

The present invention enables network traffic (e.g., packets, frames, sequences, etc.) to be associate with a user. In this manner, one or more WAN links (or portions of one or more WAN links) can be dedicated for use by a particular user, group of users or nodes. The allocation of WAN link resources to particular network activities can be based on any criteria that can be measured by network instrumentation. For example, an administrator can authorize more WAN link resources to be allocated to a user or a group of users during different times of day. In this manner an office can be allocated more WAN link resources during business hours to improve productivity while at night a datacenter is allocated more WAN link resources to reduce the time needed to backup data.

In a sense the present invention virtualizes network connections in a manner akin to the virtualization of mass storage. The invention enables disparate communication resources (e.g., network connections), to be pooled and then allocated to particular tasks, users and applications in a manner that hides details (e.g., bandwidth, quality of service, cost, reliability, etc.) of any particular physical network connection resources from those tasks, users and applications. The network resources can be allocated with finer granularity than provided by the physical resources originally. This pooling can be done with communication resources that are provided using disparate physical technologies (e.g., wired and wireless resources) as well as resources having disparate bandwidths. The pooled resources can be allocated to a task more efficiently than in the past.

For example, consider a system having a 10 Gb connection and multiple 1 Gb connections available in the pooled resources. When a task requires 3 Gb bandwidth the present invention can allocate three 1 Gb connections, or allocate a fraction of a 10 Gb connection. Alternatively, if 8 Gb of the 10 Gb resource are already consumed, the system of the present invention can allocate the remaining 2 Gb from the 10 Gb resource and augment that bandwidth with resources from one of the 1 Gb connections. The choice of which resources to allocate may be made based on cost, reliability, redundancy, priority, quality of service, or any other criteria specified by the system operator or user.

As another example, the present invention can also allocate WAN link resources based on billing and/or accounting records. In this manner, users that pay a premium can be allocated more WAN links or different WAN links than standard users. The allocation of network resources can be altered as frequently as practical for a particular application. This allows a network operator to offer differentiated service flexibly and dynamically.

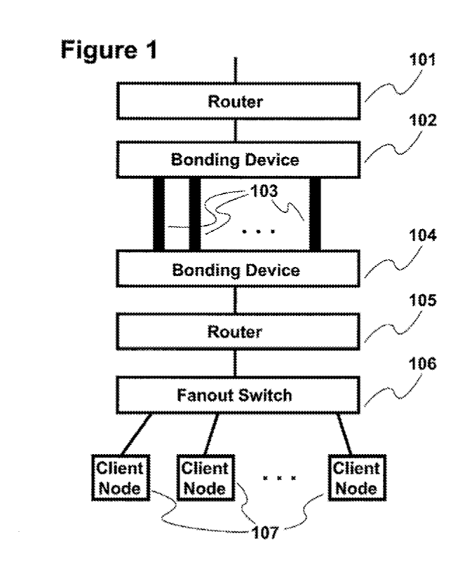

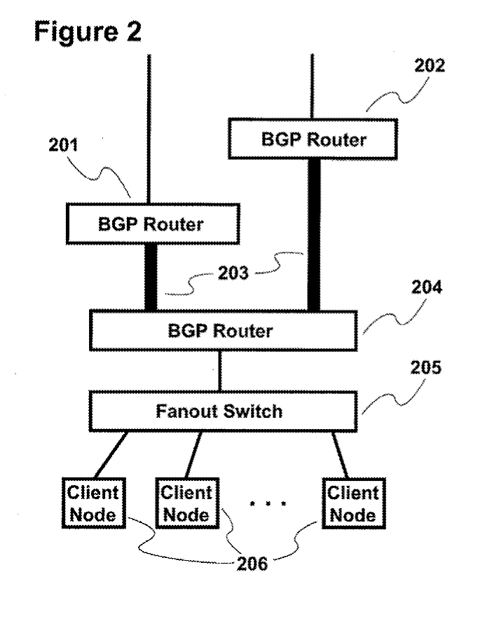

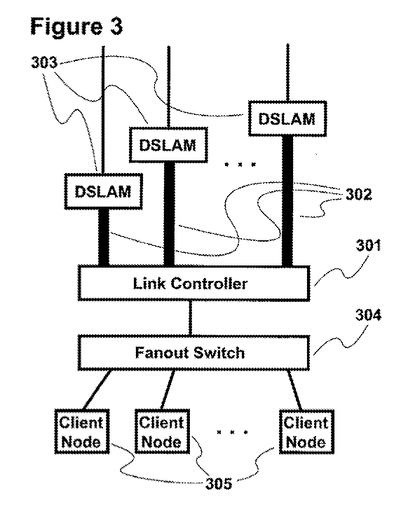

Provisioning of multiple wide area network links is typically accomplished through multilink bonding (shown in FIG. 1) or network multi-homing (shown in FIG. 2). Link control (shown in FIG. 3) is quickly becoming a popular alternative that combines many of the features of both multilinking and multi-homing while overcoming many of their difficulties. However, link control has its own set of unique challenges.

FIG. 1 shows a typical prior art multilink bonding network topology. A router (101) and bonding device (102) on the wide area network is used to interleave traffic over a series of network links (103). A similar bonding device (104) and router (105) are present on the local area network to reassemble the interleaved traffic so that connectivity may be established via a fanout switch (106) for client nodes (107) to use.

FIG. 2 shows a typical prior art multi-homed network topology where a series of BGP routers (201, 202, 204) share routing information about wide area network links (203) to establish internetwork connectivity that can be distributed through a fanout switch (205) to a series of client nodes (206).

FIG. 3 shows a typical link prior art control network topology where a link controller (301) aggregates a series of DSL lines (302) that terminate at remote DSLAMs (303) in the telephone company central office. The resulting aggregated network connectivity is distributed via a fanout switch (304) to a series of client nodes (305).

A typical link controller treats all provisioned links identically. This is a natural consequence of the design goal of standard link controllers being the aggregation of ADSL lines to obtain large amounts of bandwidth while maintaining low monthly recurring charges. Since HTTP is the dominant form of traffic found on most networks, a battery of link controlled DSLs achieves the desired goal. However, network needs are rapidly changing.

Voice over IP (VoIP) telephony is becoming an increasingly important network service. VoIP requires the same bandwidth upstream and downstream. Thus the traditional link control topology that aggregates multiple ADSLs fails to support a VoIP heavy network. The possible solutions to this problem are to return to the model of using a single high bandwidth leased line (e.g., T-3), or using a link controller to provision multiple SDSLs and/or T-1 links. Both of those solutions are prohibitively expensive and particularly unpalatable to network operators who have deployed low cost link controlled ADSL topologies.

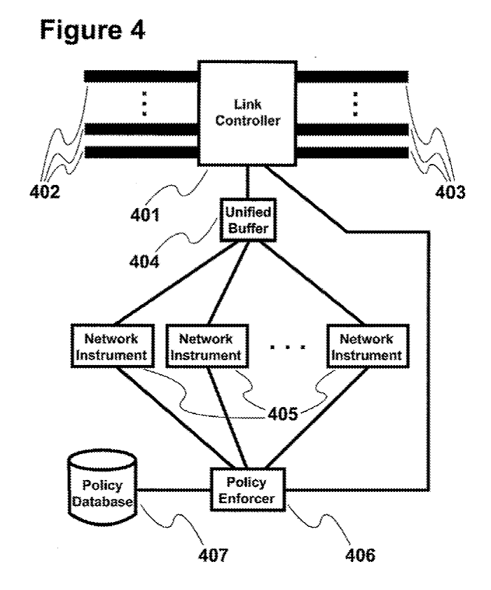

FIG. 4 shows the architecture of a directed multiplexing link controller in accordance with the present invention. A standard link controller (401) that is provisioning one or more local area network links (402) and multiple wide area network links (403) is configured to deposit packet data and link meta data into a unified buffer (404). A battery of instruments (405) interprets the data in the unified buffer (404) and passes summarized results to a policy enforcer (406) that draws administrator defined policies from a policy database (407). The instruments 405 are configured to analyze the contents of buffer 404 at any desired level of granularity. For example, an instrument 405 may analyze at the packet level (i.e., an entire IP packet), or larger quantities of data such as sequences, frames, flows, and/or any other quantity or grouping of data that might be appropriate for a particular task.

The policy enforcer (406) then controls the flow of packets between the local area network links (402) and the wide area network links (403) by dynamically modifying the configuration of the link controller (401). In cases where one or more instruments 405 are configured to analyze larger data quantities such as sequences or flows, policy enforcer 406 may operate on entire groups of packets. For example, a group of packets may be recognized individually as containing file transfer protocol (FTP) data. By examining a larger group of packets it can be recognized by instruments 405 and policy enforcer 406 that the group relates to a common FTP transfer. Based on, for example, source ID and destination ID of this transfer all of the recognized packets can be routed over a particular connection or connections selected for use by FTP traffic. In this manner the FTP transfer can be accelerated if desired, or, alternatively, delayed to prevent a low priority FTP activity from consuming bandwidth that is useful for other tasks, applications and/or users.

The present invention provides an alternative solution to problems in the prior art. By integrating a link controller (401) with a battery of network instruments (405) and a policy enforcement engine (406), the present invention can direct traffic based on a wide variety of parameters including but not limited to authentication information (e.g., username, digital certificates, and the like), authorization profiles (e.g., predefined configured use limitations), accounting/billing records (e.g., differential service levels based upon payment by a particular user or group of users), link characteristics, network traffic type, source and/or destination address, link saturation and overall network load. The present invention is readily extended to handle a wide variety of traffic and network characteristics based upon information that can be monitored by network instruments 405.

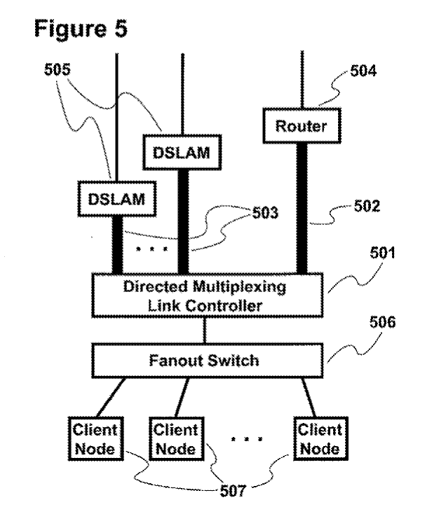

FIG. 5 shows a network topology that can be achieved by leveraging the capabilities of the directed multiplexing link controller in accordance with the present invention. The directed multiplexing link controller 501 is capable of provisioning disparate links such as a T-1 502 and a battery of DSLs 503. The T-1 502 terminates at a router 504 at a remote ISP while the battery of DSLs 503 terminate at DSLAMs 505 at a telephone company central office. The directed multiplexing link controller 501 is configured to distribute differentiated service via a fanout switch 504 to a series of client nodes 506.

In a particular implementation shown in FIG. 5, a network operator configures the directed multiplexing link controller 501 by creating a policy database 407 (shown in FIG. 4) that contains a plurality of policy records define how traffic should be multiplexed for that application. For example, the operator may choose to direct all VoIP traffic originating from the client nodes 507 to use a T-1 502 that has symmetric upstream and downstream bandwidth characteristics. Meanwhile, HTTP traffic is directed to a battery of ADSLs 503 that are lower cost and better fit the bandwidth utilization characteristics of web traffic. A combination of ADSLs and T-1 s can be provisioned by the directed multiplexing link controller of the present invention to implement the topology shown in FIG. 5 in lieu of leasing a T-3 line, saving the network operator over $3,000 per month.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

What is claimed is:

1. A link controller comprising:
a plurality of external network ports configured to couple to one or more external networks; a plurality of internal network ports configured to couple to one or more internal networks; processes within the link controller for multiplexing traffic between the one or more internal networks and the one or more external networks;
processes within the link controller for depositing packet data from the traffic into an external packet analysis system;
processes within the link controller for receiving control information from the external packet analysis system, wherein the link controller controls the flow of traffic between the internal network ports and the external network ports based at least in part on the control information received from the external packet analysis system.

2. The link controller of claim 1 wherein the external packet analysis system comprises a unified memory for holding packet data and packet metadata.

3. The link controller of claim 2 wherein the external packet analysis system comprises a plurality of instrumentation modules coupled to the unified memory and configured to analyze portions of the packet data and/or packet metadata in real time.

4. The link controller of claim 3 wherein the external packet analysis system further comprises:
a policy enforcement component coupled to the instrumentation modules and coupled to a control interface of the link controller;
a policy database coupled to the policy enforcement component, wherein the policy enforcement component retrieves policy information from the policy database in response to the analysis results from the instrumentation and enforces the policy information by sending the control information to the link controller.

5. The link controller of claim 3 wherein at least one of the instrumentation modules monitors link characteristics.

6. The link controller of claim 3 wherein at least one of the instrumentation modules monitors network traffic type.

7. The link controller of claim 3 wherein at least one of the instrumentation modules monitors source and/or destination address.

8. The link controller of claim 3 wherein at least one of the instrumentation modules monitors link saturation.

9. The link controller of claim 3 wherein at least one of the instrumentation modules monitors overall network load.

10. A link controller configured to modify the multiplexing behavior of the link controller based on parameters including link characteristics, network traffic type, source and/or destination address, link saturation and overall network load.

11. A system for managing network traffic comprising:
a link controller;
a unified buffer coupled to the link controller, wherein the link controller is configured to deposit packet data and link meta data into the unified buffer;
one or more instruments coupled to the unified buffer and configured to interpret the data in the unified buffer and pass summarized results;
a policy enforcer configured to receive the summarized results and access defined policies from a policy database; and
wherein the policy enforcer is coupled to the link controller and controls the flow of packets between the local area network links and the wide area network links by dynamically modifying the configuration of the link controller in accordance with the defined policies.

12. The system of claim 11 wherein the one or more instruments interpret the data substantially in real time.

13. The system of claim 11 wherein at least one of the instruments monitors link characteristics.

14. The system of claim 11 wherein at least one of the instruments monitors network traffic type.

15. The system of claim 11 wherein at least one of the instruments monitors source and/or destination address.

16. The system of claim 11 wherein at least one of the instruments monitors link saturation.

17. The system of claim 11 wherein at least one of the instruments monitors overall network load.

18. A system for provisioning disparate links comprising:
a first link terminating at a router at a remote ISP;
a second link terminating at DSLAMs at a telco central office;
a fanout switch coupled to a plurality of client nodes; and
a directed multiplexing link controller configured to distribute differentiated service via the fanout switch to the series of client nodes.

19. The system of claim 18 wherein the first link comprises a T-1.

20. The system of claim 19 wherein the second link comprises a battery of digital subscriber line (DSL) links.

21. A method for directing network traffic comprising:
providing a link controller coupled to a plurality of WAN links and a plurality of internal network links;
using network instrumentation to determine a value of at least one parameter of data traffic on at least one of the internal network links;
identifying a policy associated with the at least one parameter; and
directing the data traffic to one or more of the WAN links based at least in part on enforcing the identified policy.
